(19) United States
(12) Patent Application Publication
(10) Pub. No.: US 2013/0160579 A1
(43) Pub. Date: Jun. 27, 2013

(54) SEAL ASSEMBLY AND POWER STEERING APPARATUS HAVING THE SAME

(71) Applicant: Mando Corporation, Pyeongtaek-Si (KR)

(72) Inventor: Jong Baek Lee, Gangwon-do (KR)

(73) Assignee: Mando Corporation, Pyeongtaek-Si (KR)

(21) Appl. No.: 13/722,565

(22) Filed: Dec. 20, 2012

(30) Foreign Application Priority Data
Dec. 23, 2011 (KR) 10-2011-0141396

(51) Int. Cl. B62D 3/12; F16J 15/16

(52) U.S. Cl. CPC B62D 3/12; F16J 15/16
USPC 74/29; 277/500

(57) ABSTRACT

Disclosed are a seal assembly and a power steering apparatus having the same. The seal assembly is configured to prevent the leakage of hydraulic oil in a cylinder tube, and when excessive reverse input is transmitted from vehicle wheels, to prevent the fracture of a sealing member.

### CROSS-REFERENCE TO RELATED APPLICATION

This application claims priority from and the benefit under 35 U.S.C. §119(a) of Korean Patent Application No. 10-2011-0141396, filed on Dec. 23, 2011, which is hereby incorporated by reference for all purposes as if fully set forth herein.

### BACKGROUND OF THE INVENTION

1. Field of the invention

The present relates to a seal assembly and a power steering apparatus having the same, and more particularly, to a seal assembly in which in a power steering apparatus for a vehicle, an oil seal mounted in a cylinder tube and a bush are formed integrally with each other, and a power steering apparatus having the seal assembly.

2. Description of the Prior Art

As generally known in the art, a steering apparatus is provided between a driver seat and vehicle wheels so as to allow a driver to move the wheels, and includes a steering shaft provided below a steering handle of the driver seat, a rotary valve connected with the steering shaft, and a cylinder tube extending to left and right sides to be connected to the vehicle wheels so that the vehicle wheels can be directly operated according to the action of the rotary valve.

FIG. 1 is a cross-sectional view illustrating a conventional cylinder tube for a vehicle steering apparatus.

Referring to FIG. 1, the vehicle steering apparatus 100 is provided with a rotary valve 110 which is vertically installed. The rotary valve 110 is configured to control oil supplied from the outside, and is provided with an input shaft 120 in the inside thereof to be connected with a steering shaft (not illustrated) to receive torque produced and transmitted from the steering handle. In addition, the input shaft 120 is provided with a pinion gear (not illustrated) on the outer periphery of the lower part of the input shaft 120, in which the pinion gear is rotated by the torque transmitted through the input shaft 120. Furthermore, on the outside of the lower part of the rotary valve 110, there is provided a cylinder tube 130 which is formed integrally with the rotary valve 110 and extends to the opposite sides.

The cylinder tube 130 is a hollow tube that is provided to be capable of forming a space in which oil supplied through the rotary valve 110 flows, and the cylinder tube 130 is opened at opposite ends. An oil seal 180 is installed in an opened inlet side of the cylinder tube 130, and a bellows 140 is installed on the outer periphery of the cylinder tube 130. In addition, a rack bar 150 is provided in the inside of the cylinder tube 130, in which the rack bar 150 is formed with a rack gear at the longitudinally central portion thereof to be engaged with a pinion gear installed in the inside of the rotary valve 110.

The rack bar 150 is configured to be axially movable in the inside of the cylinder tube 130, in which the left and right sides are configured to move tie rod ends 170 which are directly connected with the vehicle wheels. In addition, at a side of the rack bar 150, a piston 160 is provided which is configured to be tightly contacted with the inner surface of the cylinder tube 130 and to be slidable in the inside of the cylinder tube 130.

However, the conventional vehicle steering apparatus configured as described above has a problem in that when excessive reverse input is transmitted from the wheels, the oil seal 180 that wraps the rack bar 150 in the cylinder tube 130 may be damaged due to the deformation of the rack bar 150.

### SUMMARY OF THE INVENTION

Accordingly, the present invention has been conceived in an effort to solve the above-mentioned problems occurring in the prior art, and an object of the present invention is to provide a seal assembly which prevents the leakage of hydraulic oil in a cylinder tube and the fracture of a sealing member, and a power steering apparatus having such a seal assembly.

In addition, the present invention is not limited to this, and other objects not described herein can be clearly understood by one ordinarily skilled in the art from the description provided below.

In order to accomplish this object, there is provided a seal assembly configured to be fitted on a rack bar in a cylinder tube to block the leakage of hydraulic oil, the seal assembly including: a sealing member fitted on the rack bar to be in close contact with the outer peripheral surface of the rack bar; and a spacer connected to a side of the sealing member, and configured to protect the sealing member when the rack bar is bent.

The sealing member may be provided in a ring shape, and a plate member may be inserted into the sealing member along the periphery thereof. In addition, the spacer may be provided in a ring shape, and a coating layer may be formed on an inner surface of the spacer along the periphery thereof.

The sealing member may be further provided with a backup ring at the rear side of the inner surface thereof.

The sealing member may be provided with a protrusion part, which protrudes radially inwardly from the sealing member, at the front side of the inner surface thereof.

The protrusion part may be formed with a groove at the radially outside thereof along the outer periphery of the sealing member, and an elastic member may be inserted into the groove.

In accordance with another aspect of the present invention, there is provided power steering apparatus including: a rack bar configured to convert a rotational movement of a steering wheel into a rectilinear movement; a cylinder tube, within which the rack bar is incorporated; a sealing member fitted on the rack bar to be tightly contacted with the outer peripheral surface of the rack bar; and a spacer connected to a side of the sealing member, and configured to protect the sealing member when the rack bar is bent.

The sealing member may be provided in a ring shape, and a plate member may be inserted into the sealing member along the periphery thereof. The spacer may be provided in a ring shape, and a coating layer may be formed on an inner surface of the spacer along the periphery thereof.

The sealing member may be further provided with a backup ring at the rear side of the inner surface thereof.

The sealing member may be provided with a protrusion part, which protrudes radially inwardly from the sealing member, at the front side of the inner surface thereof.

The protrusion part may be formed with a groove at the radially outside thereof along the outer periphery of the sealing member, and an elastic member may be inserted into the groove.

According to the aspects of the present invention, it is possible to prevent the leakage of hydraulic oil in a cylinder tube, and to prevent the fracture of the sealing member when excessive reverse input is transmitted from the vehicle wheels.

### BRIEF DESCRIPTION OF THE DRAWINGS

The above and other objects, features and advantages of the present invention will be more apparent from the following detailed description taken in conjunction with the accompanying drawings, in which:

FIG. 1 is a cross-sectional view illustrating a conventional cylinder tube for a vehicle steering apparatus;

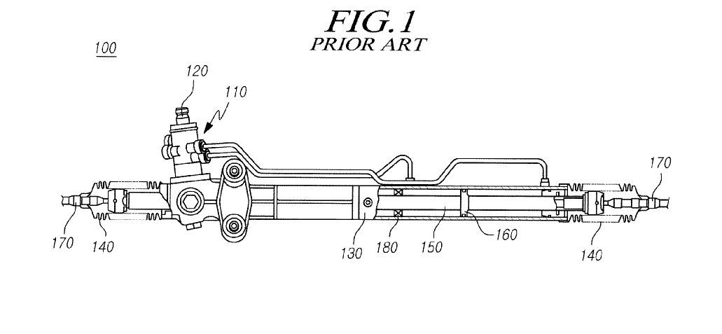

FIG. 2 is a cross-sectional view illustrating a vehicle power steering apparatus which is equipped with a seal assembly according to an exemplary embodiment of the present invention;

FIG. 3 is a perspective view illustrating the construction of the seal assembly of FIG. 2; and

FIG. 4 is a cross-sectional view illustrating the construction of the seal assembly of FIG. 3.

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

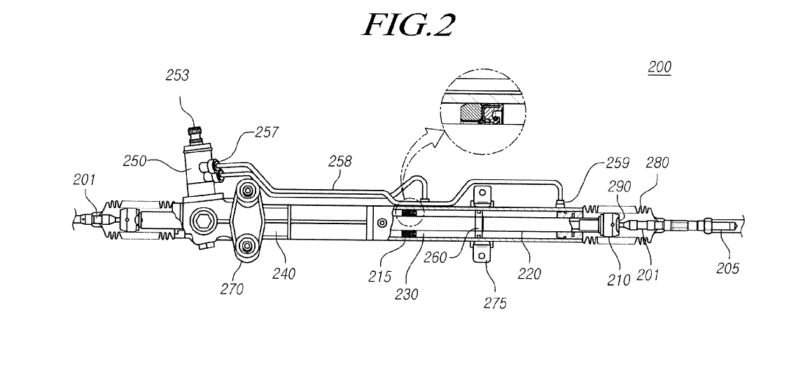

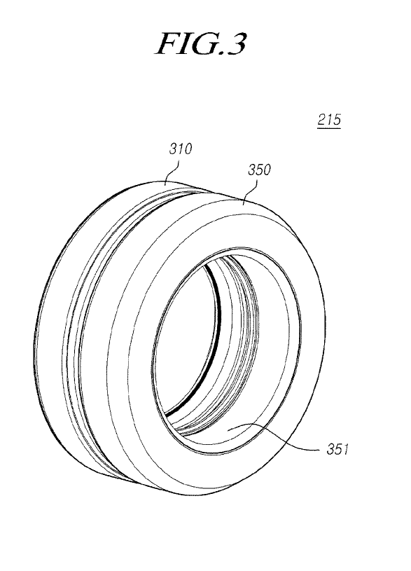

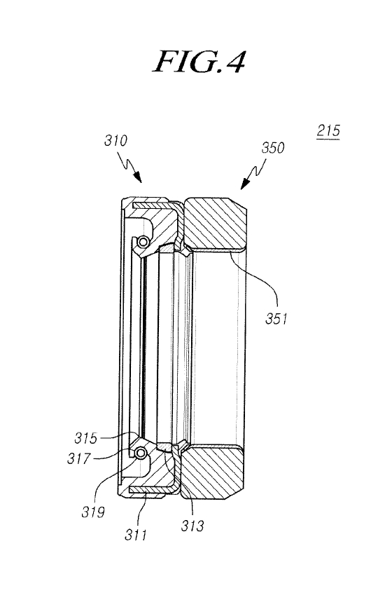

FIG. 2 is a cross-sectional view illustrating a vehicle power steering apparatus which is equipped with a seal assembly according to an exemplary embodiment of the present invention, FIG. 3 is a perspective view illustrating the construction of the seal assembly of FIG. 2, and FIG. 4 is a cross-sectional view illustrating the construction of the seal assembly of FIG. 3.

Referring to FIG. 2, a vehicle power steering apparatus 200 is configured such that hydraulic oil supplied by a hydraulic pump (not illustrated) is supplied to left and right chambers in a cylinder tube 230 through a hydraulic valve and two feed tubes 258, and a rack bar 220 is installed in the inside of the cylinder tube 230. A piston 260 is installed on the rack bar 220, and a seal assembly 215 is fitted on the rack bar 220 to be tightly contacted with the outer periphery of the rack bar 220 in the inside of the cylinder tube 230.

Referring to FIGS. 2 to 4, the seal assembly 215 includes a sealing member 310 and a spacer 350. The sealing member 310 is fitted on the rack bar 220 to be tightly contacted with the outer periphery of the rack bar 220. As an example, the sealing member 310 may be provided in a ring shape.

In the inside of the sealing member 310 a plate member 311 is inserted along the periphery thereof. As an example, the plate member 311 may be formed from a metallic material. The plate member 311 executes a frame function that prevents the shape of the sealing member 310 from being deformed. A backup ring 313 is inserted in the rear side of the inner surface of the sealing member 310.

As an example, the backup ring 313 is provided in a ring shape formed from a metallic material. The backup ring 313 prevents the shape of the sealing member 310 from being deformed. In the front portion of the inner surface of the sealing member 310, a protrusion part 315 is formed which protrudes radially inwardly from the sealing member 310. The protrusion part 315 may be provided as a rib with an edge. In such a case, the edge of the protrusion part 315 is in line contact with the outer periphery of the rack bar 220.

Alternatively, the protrusion part 315 may be provided as a rib with a curved surface. In such a case, the curved surface of the protrusion part 315 is in area contact with the outer periphery of the rack bar 220. The protrusion part 315 enhances the adhesiveness between the sealing member 310 and the rack bar 220. The protrusion part 315 is formed with a groove 317 at the radially outside thereof and along the outer periphery of the sealing member 310. An elastic member 319 is inserted into the groove 317. As an example, the elastic member 319 may be a rubber band.

The elastic member 319 compresses the protrusion part 315 inwardly in the radial direction of the sealing member 310, thereby enhancing the adhesiveness between the sealing member 310 and the rack bar 220.

A spacer 350 is connected to a side of the sealing member 310. The spacer 350 prevents the sealing member 310 from being damaged when the rack bar 220 is bent.

As an example, the spacer 350 is provided in a ring shape. The spacer 350 may be formed from a urethane material. The spacer 350 is formed with a coating layer 351 around the inner periphery thereof. As an example, the coating layer 351 may be formed from a Teflon material.

The seal assembly 215 according to the present exemplary embodiment is provided with the sealing member 310 and the spacer 350 which are formed integrally with each other, and is mounted in the cylinder tube 230 as described above. As such, the seal assembly 215 can prevent the leakage the hydraulic oil in the cylinder tube 230, and when excessive reverse input is transmitted from the vehicle wheels, the seal assembly 215 can prevent the fracture of the sealing member 310.

Referring to FIG. 2 again, the rack bar 220 is provided with a piston 260 at the longitudinally central area thereof. The piston 260 bisects the internal space of the cylinder tube 230, and is slid by the hydraulic oil flowing into the internal space such that the rack bar 220 can be moved leftward or rightward.

A pinion valve assembly (not illustrated) is incorporated in a valve body housing 250. The pinion valve assembly (not illustrated) receives a torsional signal of the steering wheel and then opens or closes the valve to form a flow path of the hydraulic oil. In the inside of the pinion valve assembly (not illustrated), an input shaft 253 is provided which protrudes upward and is connected with the steering wheel.

In the outside of the valve body housing 250, a valve port 257 is provided which supplies the hydraulic oil into the cylinder tube 230. The feed tubes 258 connect the valve ports 257 and the cylinder port 259, so that the hydraulic oil is supplied to the cylinder tube 230.

Within the cylinder tube 230, a rod-shaped rack bar 220 is installed to extend leftward and rightward through the opposite ends of the cylinder tube 230. The rack bar 220 is provided with sockets 210 at the opposite ends thereof, into which ball seats (not shown) are inserted, respectively, in such a manner that the ball seats are joined with tie rod balls 290 as ball joints.

An end of the pinion housing 240 is press-fitted to the cylinder tube 230, and is mounted in a vehicle by a mounting bush 270 provided on the pinion housing 240 and a mounting clamp 275 provided on the cylinder tube 230.

The bellows 280 is provided at each end of the cylinder tube 230. The bellows 280 encloses the ball joint part between a ball seat-inserted socket 210 and a tie rod ball 290, thereby preventing water penetration into the socket 210 and the cylinder tube 230.

The tie rods 201 are joined to the opposite ends of the rack bar 220 as ball joints, respectively. At the end of each tie rod 201, a tie rod end 205 is screw-coupled with the tie rod 201, in which the tie rod end 205 is formed to be capable of being connected with a vehicle wheels' axle.

According to the exemplary embodiment of the present invention as described above, the leakage of hydraulic oil in the cylinder tube can be prevented and when excessive reverse input is transmitted from the vehicle wheels, the fracture of the sealing member can be prevented.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. A seal assembly configured to be fitted on a rack bar in a cylinder tube to block the leakage of hydraulic oil, the seal assembly comprising:
a sealing member fitted on the rack bar to be in close contact with the outer peripheral surface of the rack bar; and
a spacer connected to a side of the sealing member, and configured to protect the sealing member when the rack bar is bent.

2. The seal assembly as claimed in claim 1, wherein the sealing member is provided in a ring shape, and a plate member is inserted into the sealing member along the periphery thereof, and
wherein the spacer is provided in a ring shape, and a coating layer is formed on an inner surface of the spacer along the periphery thereof.

3. The seal assembly as claimed in claim 2, wherein the sealing member is further provided with a backup ring at the rear side of the inner surface thereof.

4. The seal assembly as claimed in claim 3, wherein the sealing member is provided with a protrusion part, which protrudes radially inwardly from the sealing member, at the front side of the inner surface thereof.

5. The seal assembly as claimed in claim 4, wherein the protrusion part is formed with a groove at the radially outside thereof along the outer periphery of the sealing member, and an elastic member is inserted into the groove.

6. A power steering apparatus comprising:
a rack bar configured to convert a rotational movement of a steering wheel into a rectilinear movement;
a cylinder tube, within which the rack bar is incorporated;
a sealing member fitted on the rack bar to be tightly contacted with the outer peripheral surface of the rack bar; and
a spacer connected to a side of the sealing member, and configured to protect the sealing member when the rack bar is bent.

7. The power steering apparatus as claimed in claim 6, wherein the sealing member is provided in a ring shape, and a plate member is inserted into the sealing member along the periphery thereof, and
wherein the spacer is provided in a ring shape, and a coating layer is formed on an inner surface of the spacer along the periphery thereof.

8. The power steering apparatus as claimed in claim 7, wherein the sealing member is further provided with a backup ring at the rear side of the inner surface thereof.

9. The power steering apparatus as claimed in claim 8, wherein the sealing member is provided with a protrusion part, which protrudes radially inwardly from the sealing member, at the front side of the inner surface thereof.

10. The power steering apparatus as claimed in claim 9, wherein the protrusion part is formed with a groove at the radially outside thereof and along the outer periphery of the sealing member, and an elastic member is inserted into the groove.
